(19) United States
(12) Patent Application Publication
(10) Pub. No.: US 2020/0248560 A1
(43) Pub. Date: Aug. 6, 2020

(54) TANDEM FAN FOR BOUNDARY LAYER INGESTION SYSTEMS

(71) Applicant: UNITED TECHNOLOGIES CORPORATION, Farmington, CT (US)

(72) Inventors: Michael M. Joly, Hebron, CT (US); Dilip Prasad, North Granby, CT (US); Om P. Sharma, South Windsor, CT (US)

(73) Assignee: UNITED TECHNOLOGIES CORPORATION, Farmington, CT (US)

(21) Appl. No.: 16/781,829

(22) Filed: Feb. 4, 2020

Related U.S. Application Data
(60) Provisional application No. 62/801,291, filed on Feb. 5, 2019.

(51) Int. Cl. F01D 5/14; B64D 27/14; B64D 33/02

(52) U.S. Cl. CPC F01D 5/146; B64D 2033/0226; B64D 33/02; B64D 27/14

(57) ABSTRACT

A tandem fan for a boundary layer ingestion engine is disclosed. In various embodiments, the tandem fan includes a fan disk configured for rotation about a longitudinal axis; a primary fan blade extending radially from the fan disk, the primary fan blade having a primary fan blade span; and a secondary fan blade extending radially from the fan disk, the secondary fan blade having a secondary fan blade span within about ninety percent to about one-hundred percent of the primary fan blade span.

### CROSS-REFERENCE TO RELATED APPLICATIONS

This application claims priority to U.S. Prov. Appl. 62/801,291, entitled “Tandem Fan for Boundary Layer Ingestion Systems,” filed Feb. 5, 2019, the entirety of each of which is incorporated herein by reference for all purposes.

### FIELD

The present disclosure relates generally to gas turbine engines and, more particularly, to gas turbine engines and tandem fans configured for boundary layer ingestion.

### BACKGROUND

Conventional aircraft typically employ pylons to space one or more gas turbine engines away from boundary layers that form on the surfaces of the aircraft, such as, for example, the wings or fuselage. Recent advances in airframe and engine technologies have led to positioning the engines directly adjacent to or partially integrated within the wings or fuselage. While these design features may increase energy efficiencies and decrease adverse environmental impacts—e.g., noise—the design features have led to technical difficulties related to boundary layer ingestion. For example, in embodiments where the engines are positioned within the boundary layer that forms around the wings or fuselage, the engines may be subjected to distortion associated with boundary layer ingestion. Engines mounted directly adjacent the fuselage or wings are known in the art as boundary layer ingestion (BLI) engines. There are different design considerations for a BLI engine compared to a conventional engine due to the impact of the boundary layer on engine operation.

### SUMMARY

A tandem fan for a boundary layer ingestion engine is disclosed. In various embodiments, the tandem fan includes a fan disk configured for rotation about a longitudinal axis; a primary fan blade extending radially from the fan disk, the primary fan blade having a primary fan blade span; and a secondary fan blade extending radially from the fan disk, the secondary fan blade having a secondary fan blade span within about ninety percent to about one-hundred percent of the primary fan blade span.

In various embodiments, the secondary fan blade span is about equal to the primary fan blade span. In various embodiments, the primary fan blade includes a primary fan blade tip configured for disposition a primary tip distance away from a radially inner surface of a fan case within about one percent to about five percent of the primary fan blade span. In various embodiments, the secondary fan blade includes a secondary fan blade tip configured for disposition a secondary tip distance away from the radially inner surface of the fan case within about one percent to about five percent of the secondary fan blade span. In various embodiments, both the primary tip distance and the secondary tip distance are equal.

In various embodiments, the primary fan blade includes a primary fan blade trailing edge and the secondary fan blade includes a secondary fan blade leading edge and the secondary fan blade leading edge is positioned axially forward of the primary fan blade trailing edge by a first distance. In various embodiments, the first distance is within about zero percent to about thirty percent of the primary fan blade chord.

In various embodiments, the primary fan blade includes a primary fan blade leading edge and the secondary fan blade includes a secondary fan blade trailing edge and the secondary fan blade trailing edge is positioned axially aft of the primary fan blade leading edge by a second distance. In various embodiments, the second distance is within about one-hundred percent to about two-hundred fifty percent of the primary blade chord. In various embodiments, at least one of the primary fan blade tip and the secondary fan blade tip is connected to a shroud.

A boundary layer ingestion engine is disclosed. In various embodiments, the engine includes a fan case; a spool operably coupled to at least one of an electric motor and a gas turbine engine; and a tandem fan operably coupled to the spool, the tandem fan comprising a fan disk configured for rotation about a longitudinal axis, a primary fan blade extending radially from the fan disk, the primary fan blade having a primary fan blade span, and a secondary fan blade extending radially from the fan disk, the secondary fan blade having a secondary fan blade span within about ninety percent to about one-hundred percent of the primary fan blade span.

In various embodiments, the secondary fan blade span is about equal to the primary fan blade span. In various embodiments, the primary fan blade includes a primary fan blade tip configured for disposition a primary tip distance away from a radially inner surface of the fan case within about one percent to about five percent of the primary fan blade span. In various embodiments, the secondary fan blade includes a secondary fan blade tip configured for disposition a secondary tip distance away from the radially inner surface of the fan case within about one percent to about five percent of the secondary fan blade span. In various embodiments, the primary tip distance and the secondary tip distance are equal.

In various embodiments, the primary fan blade includes a primary fan blade trailing edge and the secondary fan blade includes a secondary fan blade leading edge and the secondary fan blade leading edge is positioned axially forward of the primary fan blade trailing edge by a first distance. In various embodiments, the first distance is within about zero percent to about thirty percent of the primary fan blade chord.

In various embodiments, the primary fan blade includes a primary fan blade leading edge and the secondary fan blade includes a secondary fan blade trailing edge and the secondary fan blade trailing edge is positioned axially aft of the primary fan blade leading edge by a second distance. In various embodiments, the second distance is within about one-hundred percent to about two-hundred fifty percent of the primary blade chord.

In various embodiments, the fan disk comprises a forward fan disk and an aft fan disk and both the forward fan disk and the aft fan disk are configured for rotation by the spool.

A boundary layer ingestion system configured for mounting to or downstream of a fuselage of an aircraft is disclosed. In various embodiments, the boundary layer ingestion system includes a fan case configured for attachment to or downstream of the fuselage; a tandem fan rotationally disposed within the fan case, the tandem fan including: a fan disk configured for rotation about a longitudinal axis, a primary fan blade extending radially from the fan disk, the primary fan blade having a primary fan blade span, and a secondary fan blade extending radially from the fan disk, the secondary fan blade having a secondary fan blade span, wherein the secondary fan blade span is within about ninety percent to about one-hundred percent of the primary fan blade span; and a power source configured to rotate the tandem fan.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A is a schematic view of an aircraft having a pair of boundary layer ingestion engines, in accordance with various embodiments;

FIG. 1B is a schematic view of a boundary layer ingestion engine, in accordance with various embodiments;

FIG. 2 is a schematic view of a boundary layer ingestion engine having a boundary layer of air entering the boundary layer ingestion engine, in accordance with various embodiments;

FIGS. 3A and 3B are schematic views of a boundary layer ingestion engine and a tandem fan section of the boundary layer ingestion engine, in accordance with various embodiments; and

FIGS. 4A and 4B are schematic perspective and axial views of a boundary layer ingestion engine and a tandem fan section of the boundary layer ingestion engine, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

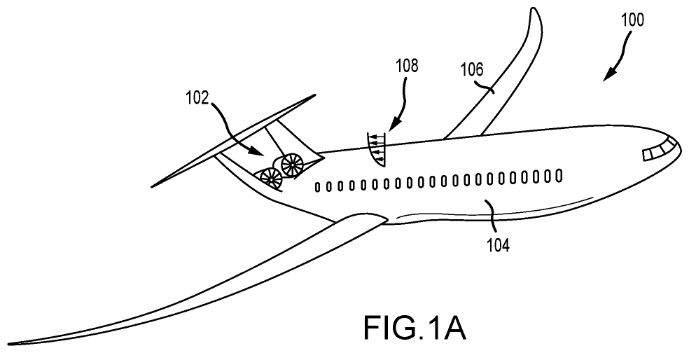

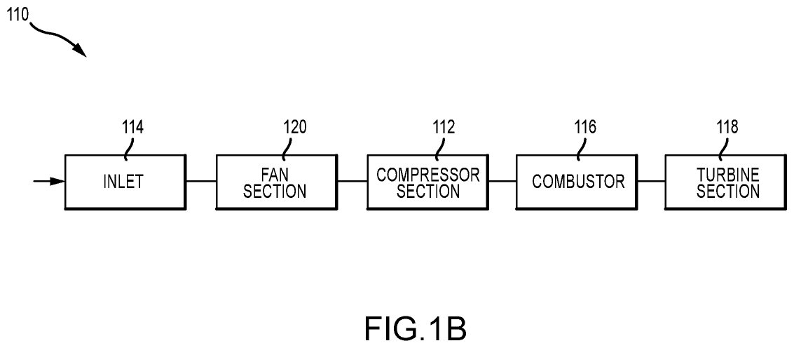

Referring now to FIG. 1A, there is illustrated an aircraft 100 having a pair of boundary layer ingestion engines 102, in accordance with various embodiments. The aircraft 100 includes a fuselage 104 and a pair of wings 106. As illustrated, a boundary layer 108 typically develops over the surfaces of the aircraft 100, including the fuselage 104 upstream of the pair of boundary layer ingestion engines 102. As discussed below, in various embodiments, the boundary layer 108 may be characterized as having a velocity that approaches zero at the surface of the fuselage 104 and that approaches the freestream velocity a distance (e.g., the boundary layer thickness) away from the surface of the fuselage 104. While a particular winged aircraft is illustrated, the disclosure contemplates other aircraft configurations, such as, for example, blended wing body aircraft or aircraft having a boundary layer ingestion engine positioned downstream of a fuselage, where the engine inlet is exposed to non-axisymmetric boundary layer distortion generated by the fuselage. Further, while the pair of boundary layer ingestion engines 102 is illustrated, the disclosure contemplates any number of such engines be mounted to or integrated within any particular aircraft.

Referring now to FIG. 1B, each of the pair of boundary layer ingestion engines 102 may comprise any propulsion engine such as, for example, a gas turbine engine 110. In various embodiments, the gas turbine engine 110 may comprise a propulsion system that includes a compressor section 112 in fluid communication with an inlet 114. Air, which is delivered into the compressor section 112 via the inlet 114, is compressed by the compressor section 112 and thereafter delivered into a combustor 116. In the combustor 116, fuel is added to the compressed air and the mixture is ignited. The byproducts of the combustion process are directed across a turbine section 118, which is connected to the compressor section 112, thereby causing rotation of the compressor section 112 and the turbine section 118. The byproducts are then expelled from the gas turbine engine 110 through an exhaust duct. Rotation of the turbine section 118 is also used to drive rotation of a fan within a fan section 120. In various embodiments, the fan within the fan section 120 may be connected to componentry within the turbine section 118 or the compressor section 112 and rotated via one or more shafts or gearboxes. While the fan section 120 is described in this disclosure as being driven by a gas turbine engine, the disclosure is not so limited, and contemplates other drivers (e.g., a power source or power sources), such as, for example, an electric motor.

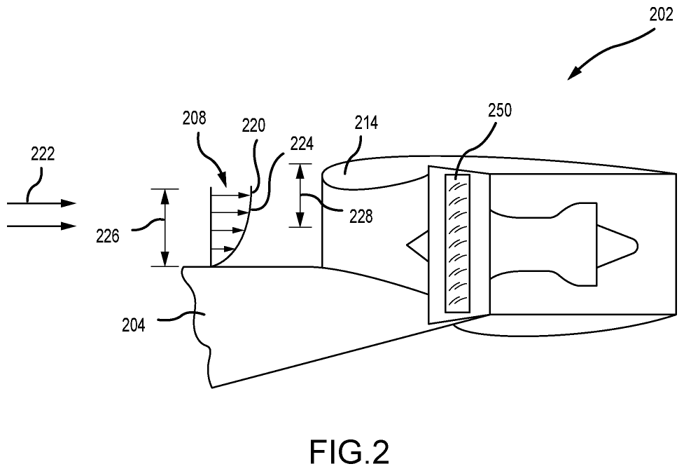

With reference now to FIG. 2, a schematic of a boundary layer ingestion engine 202 having a boundary layer 208, exhibiting a boundary layer profile 220 that is characteristic of air entering the boundary layer ingestion engine 202, is provided. The boundary layer profile 220 is illustrated in cross sectional view (i.e., in a direction perpendicular to a free stream 222 (U)). As illustrated, the boundary layer profile 220 exhibits flow characteristics (e.g., a velocity profile 224) of the boundary layer 208 that has formed over the surface of a fuselage 204 upstream of the boundary layer ingestion engine 202. Notably, the velocity profile 224 approaches zero at the surface of the fuselage 204 and the freestream velocity U a distance (e.g., a boundary layer thickness 226 (δ)) away from the surface of the fuselage 204.

In various embodiments, the boundary layer thickness δ (see 226 in FIG. 2) may be on the same order as a characteristic dimension of an inlet 214—e.g., an inlet radius 228 or diameter—of the boundary layer ingestion engine 202. For example, the boundary layer thickness δ may be defined as the distance from the surface of the fuselage 204 to a point away from the surface at which the flow velocity is 99% of the freestream velocity U. The boundary layer thickness δ at a given point along the surface is dependent on (i) an axial distance x from an upstream end of the respective surface (e.g., a leading edge of a wing or the nose of a fuselage), (ii) the freestream velocity U, and (iii) the viscosity of the air v. The following equation may be used to describe development of a turbulent boundary layer thickness δ in relation to the axial distance x:

$$δ = 0 .37 \times {( \frac{U x}{v} )}^{\frac{- 1}{5}} ,$$

where Ux/v is the Reynolds number. For typical airliners flying at cruising speed and altitude—e.g., within ranges of about 30,000-40,000 feet (≅9,000-12,000 meters) and about 400-600 mph (≅600-1,000 kph)—the boundary layer thickness δ near the inlet 214 to the boundary layer ingestion engine 202 may be on the order of one to two feet (or 30 to 60 cm) or greater, depending on the length of the aircraft or the applicable surface of the aircraft. Accordingly, as indicated in FIG. 2, substantial variation of the mass flow into the inlet 214 may be expected, leading to stresses or distortions on the engine, particularly the fan section, not typically present where the mass flow into the engine is substantially uniform across the inlet. In various embodiments, as described more fully below, the boundary layer ingestion engine 202 includes a tandem fan 250 for propulsion.

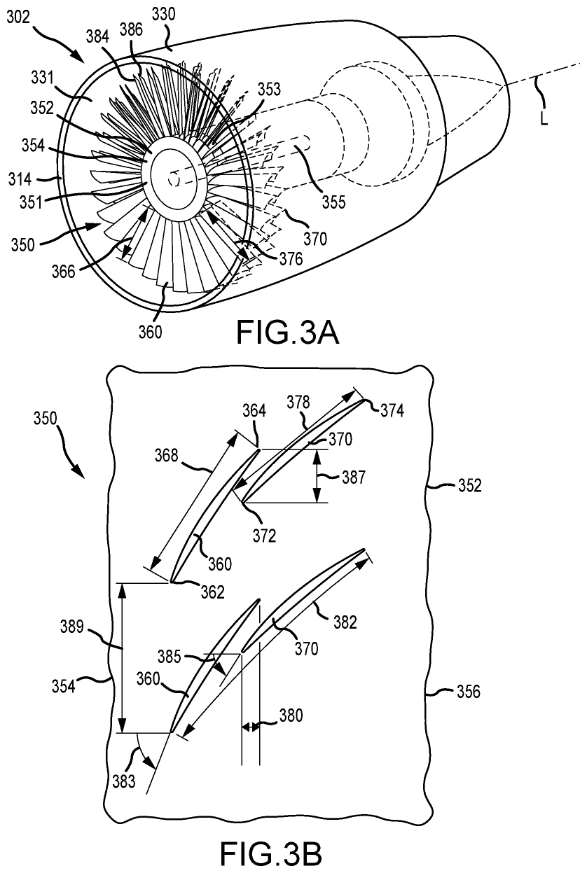

Referring now to FIG. 3A, a boundary layer ingestion engine 302 is illustrated. In various embodiments, the boundary layer ingestion engine 302 includes an inlet 314, a fan case 330 and a tandem fan 350 disposed for rotation about a longitudinal axis L extending through the fan case 330. Referring to FIGS. 3A and 3B, the tandem fan 350 includes a fan disk 352 having an upstream end 354 and a downstream end 356. A plurality of primary fan blades 360 extend radially outwardly from the fan disk 352 toward a radially inner surface 331 of the fan case 330. Each of the plurality of primary fan blades 360 includes a primary fan blade airfoil section having a primary fan blade leading edge 362, a primary fan blade trailing edge 364, a primary fan blade span 366, extending radially from the fan disk 352 to proximate the radially inner surface of the fan case 330, and a primary fan blade chord 368. A plurality of secondary fan blades 370 is disposed aft of the plurality of primary fan blades 360. Each of the plurality of secondary fan blades 370 extends radially outwardly from the fan disk 352 toward the radially inner surface of the fan case 330. Each of the plurality of secondary fan blades 370 includes a secondary fan blade airfoil section having a secondary fan blade leading edge 372, a secondary fan blade trailing edge 374, a secondary fan blade span 376, extending radially from the fan disk 352 to proximate the radially inner surface of the fan case 330, and a secondary fan blade chord 378.

In various embodiments, the secondary fan blade leading edge 372 of each of the plurality of secondary fan blades 370 is positioned a first distance 380 from the primary fan blade trailing edge 364 of each of the plurality of primary fan blades 360. In various embodiments, the first distance 380 may be a positive value, where the secondary fan blade leading edge 372 is positioned axially forward of the primary fan blade trailing edge 364 (as indicated in FIG. 3B). In various embodiments, the first distance 380 may be a negative value, where the secondary fan blade leading edge 372 is positioned axially aft of the primary fan blade trailing edge 364. In various embodiments, the secondary fan blade trailing edge 374 of each of the plurality of secondary fan blades 370 is positioned downstream or axially aft by a second distance 382 from the primary fan blade leading edge 362 of each of the plurality of primary fan blades 360. In various embodiments, the first distance 380 is within about plus thirty percent (+30%) to about minus thirty percent (−30%) of the primary fan blade chord 368. In various embodiments, the second distance 382 is within about one-hundred percent (100%) to about two-hundred percent (200%) of the primary fan blade chord 368.

In various embodiments, each of the plurality of primary fan blades 360 includes a primary fan blade tip 384 that is disposed a primary tip distance from the radially inner surface of the fan case 330. In various embodiments, the primary tip distance is between about one percent (1%) to about five percent (5%) of the primary fan blade span 366. In various embodiments, each of the plurality of secondary fan blades 370 includes a secondary fan blade tip 386 that is disposed a secondary tip distance from the radially inner surface of the fan case 330. In various embodiments, the secondary tip distance is between about one percent (1%) to about five percent (5%) of the secondary fan blade span 376. In various embodiments, both the primary tip distance and the secondary tip distance are equal. In various embodiments, the secondary fan blade span 376 is equal in value to about ninety percent (90%) to about one-hundred percent (100%) of the primary fan blade span 366. In various embodiments, the primary fan blade span 366 is about equal to the secondary fan blade span 376.

In various embodiments, each of the primary fan blades 360 exhibits a primary pitch angle 383 and each of the plurality of secondary fan blades 370 exhibits a secondary pitch angle 385. In various embodiments, the secondary pitch angle 385 is equal to about ten percent (10%) to about one-hundred percent (100%) of the primary pitch angle 383. In various embodiments, the primary fan blade trailing edge 364 of each of the plurality of primary fan blades 360 is offset a circumferential distance 387 from the secondary fan blade leading edge 372 of each of the plurality of secondary fan blades 370. In various embodiments, the circumferential distance 387 is equal to about zero percent (0%) to about one-hundred percent (100%) of a primary fan circumferential blade spacing 389.

In various embodiments, the term “about” as used in this disclosure contemplates±five percent (5%) of the indicated percentage value. In addition, the disclosure contemplates the pluralities of primary and secondary blades will exhibit blade dimensions and orientations—e.g., the various chord lengths, pitch angles and relative axial and circumferential spacings—that vary along the respective span of each of the blades. Thus, the various dimensions and orientations identified above may be considered, in various embodiments, average values taken along the length of the spans. In various embodiments, the various dimensions and orientations identified above may also be considered, for example, values exhibited at the mid span of each of the respective pluralities of blades.

In various embodiments, the fan disk 352 comprises a single disk to witch each of the plurality of primary fan blades 360 and each of the plurality of secondary fan blades 370 are attached. In various embodiments, the fan disk 352 comprises a forward fan disk 351 to which each of the plurality of primary fan blades 360 is attached and an aft fan disk 353 to which each of the plurality of secondary fan blades 370 is attached. In various embodiments, the fan disk 352 is attached to and rotated by a spool 355 (or shaft). In various embodiments, both the forward fan disk 351 and the aft fan disk 353 are attached to and rotated at the same velocity by the spool 355.

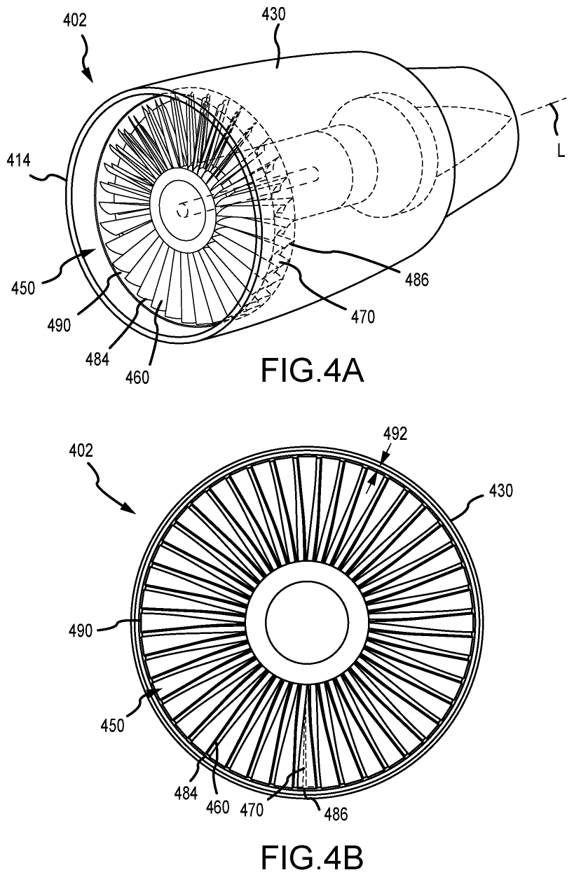

Referring now to FIGS. 4A and 4B, a boundary layer ingestion engine 402 is illustrated. In various embodiments, the boundary layer ingestion engine 402 includes an inlet 414, a fan case 430 and a tandem fan 450 disposed for rotation about a longitudinal axis L extending through the fan case 430. The boundary layer ingestion engine 402 shares many of the structural and operational characteristics of the boundary layer ingestion engine 302 above described with reference to FIGS. 3A and 3B and, therefore, such characteristics are not repeated here. In various embodiments, the tandem fan 450 includes a plurality of primary fan blades 460, each including a primary fan blade tip 484. Similarly, the tandem fan 450 includes a plurality of secondary fan blades 470, each including a secondary fan blade tip 486 (FIG. 4B illustrates only a single secondary fan blade for simplicity). In various embodiments, each primary fan blade tip 484 and each secondary fan blade tip 486 is connected to a shroud 490. In various embodiments, the shroud 490 may comprise a first half connected to the plurality of primary fan blades 460 and a second half connected to the plurality of secondary fan blades 470. In various embodiments, the first half and the second half of the shroud 490 may be separate components (e.g., separate annular rings or shrouds) or may be a single monolithic unit (e.g., a single annular ring or shroud). In various embodiments, a radially outer surface of the shroud 490 and a radially inner surface of the fan case 430 define a shroud clearance 492. In various embodiments, the shroud clearance 492 falls within the ranges described above for one or both of the primary tip distance and the secondary tip distance. Further, in various embodiments, the shroud 490 may include end wall contouring to further seal the clearance 492 between the radially outer surface of the shroud 490 and the radially inner surface of the fan case 430.

A tandem fan for use in a boundary layer ingestion engine has been described. The pluralities of primary and secondary airfoils of the tandem fan permit decoupling of Mach number effects—e.g., variations of Mach number at different locations throughout the inlet due to the presence of the boundary layer—and the turning of the mass flow through the tandem fan. The configuration achieves diffusion of shock waves and deceleration of the inlet mass flow through the primary blades having marginal camber and then turning of the mass flow via the secondary blades. The configuration thus provides for a larger work factor than a single fan since it permits greater loading of the tandem system. Hence, for a given work input, the rotational velocity of the tandem fan may be reduced, resulting in a reduction of the relative Mach number of the flow entering the tandem fan. This reduces shock-induced losses that occur in the undistorted portion of the mass flow at the inlet. Further, since the primary fan is less sensitive to incidence variations, the losses in the distorted portion of the flow may also be reduced. In addition, because the work produced by fans typically increases with the radius of the fan blades, the use of full-length (or radius) blades for both the primary stage and the secondary stage enables the tandem fan disclosed herein to more effectively realize the full amount of work achievable by the tandem fan, as opposed to tandem fans where one set of blades (typically the upstream set of blades) has a length (or radius) less than the downstream set of blades. Such embodiments having an upstream set of blades with lengths (or spans) less than the downstream set of blades are typically not intended to deliver additional work or realize the full work potential, but are intended to reduce the fundamental natural frequency of the blades within the tandem fan system for purposes of structural integrity, particularly where the upstream set of blades employs relatively thin blades relative to the thickness of the downstream set of blades.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. A tandem fan for a boundary layer ingestion engine, comprising:
a fan disk configured for rotation about a longitudinal axis;
a primary fan blade extending radially from the fan disk, the primary fan blade having a primary fan blade span; and
a secondary fan blade extending radially from the fan disk, the secondary fan blade having a secondary fan blade span within about ninety percent to about one-hundred percent of the primary fan blade span.

2. The tandem fan of claim 1, wherein the secondary fan blade span is about equal to the primary fan blade span.

3. The tandem fan of claim 1, wherein the primary fan blade includes a primary fan blade tip configured for disposition a primary tip distance away from a radially inner surface of a fan case within about one percent to about five percent of the primary fan blade span.

4. The tandem fan of claim 3, wherein the secondary fan blade includes a secondary fan blade tip configured for disposition a secondary tip distance away from the radially inner surface of the fan case within about one percent to about five percent of the secondary fan blade span.

5. The tandem fan of claim 4, wherein both the primary tip distance and the secondary tip distance are equal.

6. The tandem fan of claim 1, wherein the primary fan blade includes a primary fan blade trailing edge and the secondary fan blade includes a secondary fan blade leading edge and the secondary fan blade leading edge is positioned axially forward of the primary fan blade trailing edge by a first distance.

7. The tandem fan of claim 6, wherein the first distance is within about zero percent to about thirty percent of a primary fan blade chord.

8. The tandem fan of claim 1, wherein the primary fan blade includes a primary fan blade leading edge and the secondary fan blade includes a secondary fan blade trailing edge and the secondary fan blade trailing edge is positioned axially aft of the primary fan blade leading edge by a second distance and wherein the second distance is within about one-hundred percent to about two-hundred percent of a primary blade chord.

9. The tandem fan of claim 4, wherein at least one of the primary fan blade tip and the secondary fan blade tip is connected to a shroud.

10. A boundary layer ingestion engine, comprising:
a fan case;
a spool operably coupled to at least one of an electric motor and a gas turbine engine; and
a tandem fan operably coupled to the spool, the tandem fan comprising
a fan disk configured for rotation about a longitudinal axis,
a primary fan blade extending radially from the fan disk, the primary fan blade having a primary fan blade span, and
a secondary fan blade extending radially from the fan disk, the secondary fan blade having a secondary fan blade span within about ninety percent to about one-hundred percent of the primary fan blade span.

11. The boundary layer ingestion engine of claim 10, wherein the secondary fan blade span is about equal to the primary fan blade span.

12. The boundary layer ingestion engine of claim 11, wherein the primary fan blade includes a primary fan blade tip configured for disposition a primary tip distance away from a radially inner surface of the fan case within about one percent to about five percent of the primary fan blade span.

13. The boundary layer ingestion engine of claim 12, wherein the secondary fan blade includes a secondary fan blade tip configured for disposition a secondary tip distance away from the radially inner surface of the fan case within about one percent to about five percent of the secondary fan blade span.

14. The boundary layer ingestion engine of claim 13, wherein both the primary tip distance and the secondary tip distance are equal.

15. The boundary layer ingestion engine of claim 10, wherein the primary fan blade includes a primary fan blade trailing edge and the secondary fan blade includes a secondary fan blade leading edge and the secondary fan blade leading edge is positioned axially forward of the primary fan blade trailing edge by a first distance.

16. The boundary layer ingestion engine of claim 15, wherein the first distance is within about zero percent to about thirty percent of a primary fan blade chord.

17. The boundary layer ingestion engine of claim 10, wherein the primary fan blade includes a primary fan blade leading edge and the secondary fan blade includes a secondary fan blade trailing edge and the secondary fan blade trailing edge is positioned axially aft of the primary fan blade leading edge by a second distance.

18. The boundary layer ingestion engine of claim 17, wherein the second distance is within about one-hundred percent to about two-hundred percent of a primary blade chord.

19. The boundary layer ingestion engine of claim 10, wherein the fan disk comprises a forward fan disk and an aft fan disk and both the forward fan disk and the aft fan disk are configured for rotation by the spool.

20. A boundary layer ingestion system configured for mounting to or downstream of a fuselage of an aircraft, comprising:
a fan case configured for attachment to or downstream of the fuselage;
a tandem fan rotationally disposed within the fan case, the tandem fan including:
a fan disk configured for rotation about a longitudinal axis,
a primary fan blade extending radially from the fan disk, the primary fan blade having a primary fan blade span, and
a secondary fan blade extending radially from the fan disk, the secondary fan blade having a secondary fan blade span within about ninety percent to about one-hundred percent of the primary fan blade span; and
a power source configured to rotate the tandem fan.
